(19) United States
(12) Patent Application Publication
(10) Pub. No.: US 2004/0213824 A1
(43) Pub. Date: Oct. 28, 2004

(54) Composition for controlling termite

(75) Inventor: Takaaki Itoh, Ikeda-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/831,132

(22) Filed: Apr. 26, 2004

(30) Foreign Application Priority Data
Apr. 28, 2003 (JP) 2003-123278

(51) Int. Cl. A01N 25/08; A01N 47/28

(52) U.S. Cl. 424/410; 514/594

(57) ABSTRACT

Termites can be controlled by applying a composition comprising N-(2,6-difluorobenzoyl)-N′-[2 -chloro-3,5-bis(trifluoromethyl)phenyl]urea and dried yeast.

### FIELD OF THE INVENTION

The present invention relates to a composition for controlling termite.

### BACKGROUND OF THE INVENTION

U.S. Pat. No. 6,022,882 discloses 2-chloro-3,5-bis(trifluoromethyl)phenyl benzoylurea derivatives exhibit growth-retarding activity against insects.

The present invention provides a composition for controlling termite.

### SUMMARY OF THE INVENTION

The present invention provides a composition for controlling termite which comprises N-(2,6-difluorobenzoyl)-N′-[2-chloro-3,5-bis(trifluoromethyl)phenyl]urea (common name: bistrifluron) of formula (1):

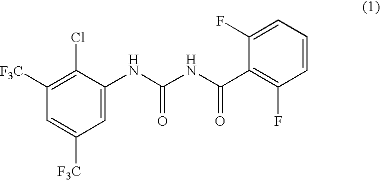

and dried yeast. Further, the present invention also provides a method for controlling termite which comprises the above-mentioned composition to a locus termites inhabit.

### DETAILED DESCRIPTION OF THE INVENTION

Bistrifluron used in the present invention is a known compound having insect growth regulating activity and can be produced by the method given in U.S. Pat. No. 6,022,882.

Yeast is a collective name for those fungi which possess, under normal conditions of growth, a vegetative body consisting, at least in part, of simple, individual cells. Typical examples include Saccharomyces yeast, Candida yeast, Pichia yeast, Hansenula yeast, Torulopsis yeast and so on. Saccharomyces spp. include S. cerevisiae, S. rouxii and so on, and Candida spp. include C. utilis, C. lipolytica and so on. Further, Saccharomyces yeast includes alcohol yeast, bakers yeast, beer yeast (brewers yeast), wine yeast, sake (Japanese alcoholic beverage made by the fermentation of rice) yeast and so on. Saccharomyces yeast is preferably used in the present invention.

Dried yeast is produced by drying yeast. The typical production procedure is carried out by sending air of 30 to 40° C. for about 10 hours with a rotary dryer. The water content in dried yeast is generally 10% or less, preferably 8% or less by weight, but dried yeast may content much water depending the state of preservation. It may or may not include living yeast, but the dried yeast having no living yeast is preferable because it is more preservative.

Dried yeast is available on the market. Dried bakers yeast is well known, and for example, produced by Asahi Food and Healthcare Limited (Asahi Breweries Group) as “Dried Yeast EBIOS.”

The composition for controlling termite of the present invention comprises bistrifluron and dried yeast. It may further comprise cellulose. The cellulose can be cellulose material such as paper, pulp, sawdust as well as cellulose itself.

The composition may further contain a solid carrier, an auxiliary and so on.

Examples of the solid carrier include a resin such as polyethylene, polypropylene, polystyrene and polyvinyl chloride; grain powder such as wheat powder and rice powder; starch such as potato starch and corn starch; and so on.

Examples of the auxiliary include a preservative such as benzoic acid, sodium benzoate, o-phenylphenol, sodium o-phenylphenolate, dehydroacetic acid and sodium dehydroacetate; antioxidant such as BHT (dibutylhydroxytoluene), BHA (butylhydroxyanisole), erythorbic acid, ascorbic acid, propyl gallate and tocopherol; desiccant such as silica gel.

In the composition for controlling termite of the present invention, the content of bistrifluron is generally 0.01 to 10% by weight, and the weight ratio of bistrifluron and dried yeast is generally in the range of 100:1 to 1:1000, preferably 1:1 to 1:20.

The weight ratio of bistrifluron and cellulose is generally in the range of 1:5 to 1:10000, preferably 1:100 to 1:500 by weight, where the composition comprises cellulose.

The composition for controlling termite of the present invention is produced by mixing bistrifluron, dried yeast, optionally cellulose, carrier, auxiliary and so on. Typical formulation is powders and tablet, which is produced by compressing the powders.

The word “termite(s)” means Isopteran insects classified in Mastotermitidae, Termopsidae, Kalotermitidae, Hodotermitidae, Rhinotermitidae, Serritermitidae and Termitidae. Typical examples include Reticulitermes speratus, Coptotermes formosanus, Incisitermes minor, Cryptotermes domesticus, Odontotermes formosanus, Neotermes koshunensis, Glyptotermes satsumensis, Glyptotermes nakajimai, Glyptotermes fuscus, Glyptotermes kodamai, Glyptotermes kushimensis, Hodotermopsis japonica, Coptotermes guangzhoensis, Reticulitermes miyatakei, Reticulitermes flaviceps, Reticulitermes kanmonensis, Nasutitermes takasagoensis, Pericapritermes nitobei, Sinocapritermes mushae, Reticulitermes flavipes (Eastern subterranean termite), Reticulitermes hesperus (Western subterranean termite), Reticulitermes virginicus (dark southern subterranean termite), Reticulitermes tibialis (arid land subterranean termite), Heterotermes aureus (desert subterranean termite) and Zootermopsis nevadensis (Nevada dumpwood termite).

The method for controlling termite of the present invention is carried out by applying the composition of the present invention to a locus termites inhabit. The application dosage of bistrifluron depends on a degree of damage and the other conditions, and it is generally 0.001 to 20 g per 1 m².

In the present method, the composition is generally applied to a locus termites inhabit, for example, termite tunnel, lumber damaged by termites, soil under a house, surroundings of a house and so on. The composition may be applied as it is, or applied by setting in a suitable container.

### EXAMPLES

The present invention is explained by formulation examples and test examples in detail below. Part(s) means part(s) by weight in the following examples.

### Formulation Example 1

A half (0.5) part of bistrifluron, 5 parts of dried beer yeast (commercial name: Dried Yeast EBIOS, produced by Asahi Food and Healthcare Limited) and 94.5 parts of flour were mixed. Two and a half grams (2.5 g) of them were compressed with a tablet machine to give a cylindrical composition (2 cm in diameter, 6 mm in height) of the present invention.

### Formulation Example 2

A half (0.5) part of bistrifluron, 5 parts of dried beer yeast (commercial name: Dried Yeast EBIOS, produced by Asahi Food and Healthcare Limited) and 94.5 parts of cellulose powder (commercial name: KC Flock, produced by Nippon Paper Industries) were mixed. Two and a half grams (2.5 g) of them were compressed with a tablet machine to give a cylindrical composition (2 cm in diameter, 6 mm in height) of the present invention.

### Formulation Example 3

A half (0.5) part of bistrifluron, 5 parts of dried bakers yeast (commercial name: Super Kameria Dried yeast, produced by Nisshin Foods Inc.) and 94.5 parts of cellulose powder (commercial name: KC Flock, produced by Nippon Paper Industries) are mixed. Two and a half grams (2.5 g) of them are compressed with a tablet machine to give a cylindrical composition (2 cm in diameter, 6 mm in height) of the present invention.

### Reference Example 1

A half (0.5) part of bistrifluron and 99.5 parts of cellulose powder (commercial name: KC Flock, produced by Nippon Paper Industries) were mixed. Two and a half grams (2.5 g) of them were compressed with a tablet machine to give a cylindrical composition (2 cm in diameter, 6 mm in height) of the present invention.

Next, test examples are shown below.

### Test Example 1

Each of the composition obtained by Formulation example 1, Formulation example 2 and Reference example 1 was set in the center of Petri dish (9 cm in diameter). Twenty termite workers (Coptotermes formosanus) were released in the plastic cup and the humidity was kept at 95%. The life and death of the termites was observed every day, and the number of days to make 90% of the termites dead was given by Table 1.

TABLE 1

| | Number of days to make 90% of the termites dead |
|---|---|
| Formulation example 1 | 23 |
| Formulation example 2 | 16 |
| Reference example 1 | 31 |

What is claimed is:

1. A composition for controlling termite which comprises N-(2,6-difluorobenzoyl)-N′-[2-chloro-3,5-bis(trifluoromethyl)phenyl]urea and dried yeast.

2. The composition according to claim 1, wherein the content of N-(2,6-difluorobenzoyl)-N′-[2-chloro-3,5-bis(trifluoromethyl)phenyl]urea is 0.01 to 10% by weight.

3. The composition according to claim 2, wherein the weight ratio of N-(2,6-difluorobenzoyl)-N′-[2-chloro-3,5-bis(trifluoromethyl)phenyl]urea and dried yeast is in the range of 1:1 to 1:20.

4. The composition according to claim 1, which comprises N-(2,6-difluorobenzoyl)-N′-[2-chloro-3,5-bis(trifluoromethyl)phenyl]urea, dried yeast and cellulose.

5. The composition according to claim 4, wherein the content of N-(2,6-difluorobenzoyl)-N′-[2-chloro-3,5-bis(trifluoromethyl)phenyl]urea is 0.01 to 10% by weight.

6. The composition according to claim 5, wherein the weight ratio of N-(2,6-difluorobenzoyl)-N′-[2-chloro-3,5-bis(trifluoromethyl)phenyl]urea and dried yeast is in the range of 1:1 to 1:20, and the weight ratio of N-(2,6-difluorobenzoyl)-N′-[2-chloro-3,5-bis(trifluoromethyl)phenyl]urea and cellulose is 1:100 to 1:500 by weight.

7. A method for controlling termites which comprises applying an effective amount of the composition described in any of claims 1-6 to a locus termites inhabit.
